(19) United States
(12) Patent Application Publication
(10) Pub. No.: US 2010/0306694 A1
(43) Pub. Date: Dec. 2, 2010

(54) INLINE VARIABLE RANGE AND TARGET SELECTOR SLIDER CONTROL

(75) Inventors: Vincent Charles Conzola, Raleigh, NC (US); Todd Michael Eischeid, Cary, NC (US); Mary Sumner Johnson, Raleigh, NC (US); Mark E. Molander, Cary, NC (US)

Correspondence Address: ZILKA-KOTAB, PC- IBM, P.O. BOX 721120, SAN JOSE, CA, 95172-1120, US

(73) Assignee: International Business Machines Corporation, Armonk, NY (US)

(21) Appl. No.: 12/476,499

(22) Filed: Jun. 2, 2009

(51) Int. Cl. G06F 3/048

(52) U.S. Cl. 715/786

(57) ABSTRACT

According to one embodiment, a method comprises generating a slider having end values and receiving designation of a range between the end values, or including no more than one of the end values, using controls on the slider. Also, the method includes receiving designation of a subrange within the designated range using the controls on the slider and updating the slider control in response to the receiving steps. In addition, the method includes outputting a digital signal to a graphical display device for graphically depicting the controls of the slider at ends of the range and subrange. Also presented in other embodiments are a computer program product and a system operable to output a slider.

### BACKGROUND

The present invention relates to manipulation of ranges in a computing environment, and more particularly, this invention relates to a slider control which includes multiple range and/or target selections.

Generally, when a window is opened in a computing environment and includes visual images and/or text that occupy more space than is available in the size of the window, slider controls will be placed on the side and/or bottom of the window to allow a user to scroll through the visual images and/or text that is not shown in the original window view.

Some slider controls also allow for a range to be specified within a total scrollable range. However, these slider controls do not allow for more than one range to be specified on a slider control, or for a range and a specific location to be specified on a slider control. Therefore, a slider control which included this type of functionality, while maintaining a similar size, look and feel to typical slider controls could prove very useful.

### SUMMARY

According to one embodiment, a method comprises generating a slider having end values and receiving designation of a range between the end values, or including no more than one of the end values, using controls on the slider. Also, the method includes receiving designation of a subrange within the designated range using the controls on the slider and updating the slider control in response to the receiving steps. In addition, the method includes outputting a digital signal to a graphical display device for graphically depicting the controls of the slider at ends of the range and subrange.

In another embodiment, a computer program product for outputting a slider includes a computer usable medium having computer usable program code embodied therewith. The computer usable program code is configured to generate a slider having end values, receive designation of a range between the end values (or including no more than one of the end values) using controls on the slider, receive designation of a subrange within the designated range using the controls on the slider, update the slider control in response to the receiving steps, and output a digital signal to a graphical display device for graphically depicting the controls of the slider at ends of the range and subrange.

A system, according to one embodiment, comprises a processor operative to execute computer usable program code and a network interface and/or a peripheral device interface for receiving user input. The system also includes a computer usable medium having computer usable program code embodied therewith. The computer usable program code is configured to generate a slider having end values, receive designation of a range between the end values (or including no more than one of the end values) using controls on the slider, receive designation of a subrange within the designated range using the controls on the slider, update the slider control in response to the receiving steps, and output a digital signal to a graphical display device for graphically depicting the controls of the slider at ends of the range and subrange.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIGS. 3A-3D illustrate a slider control according to one embodiment.

FIG. 4 shows a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

In some general embodiments, this invention provides a single user interface (UI) slider control to allow a first two-point range selection, while also simultaneously allowing the flexibly of choosing to specify a second range, which may include either a target point and/or a subrange to the first range. Also, this flexibility may be directly manipulated via the graphical part of the slider control. The advantages of this flexibility over current techniques include, but are not limited to, multiple (three or four) settings within one single control is very space efficient and more elegant than currently used controls, the direct manipulation may be very engaging, and putting all the settings within the same slider control makes them more comparable (e.g., the controls are within the same context and on the same scale).

In one general embodiment, a method includes generating a slider having end values; receiving designation of a range between the end values, or including no more than one of the end values, using controls on the slider; receiving designation of a subrange within the designated range using the controls on the slider; updating the slider control in response to the receiving steps, and outputting a digital signal to a graphical display device for graphically depicting the controls of the slider at ends of the range and subrange.

In another general embodiment, a computer program product for outputting a slider includes a computer usable medium having computer usable program code embodied therewith, the computer usable program code comprising: computer usable program code configured to generate a slider having end values; computer usable program code configured to receive designation of a range between the end values, or including no more than one of the end values, using controls on the slider; computer usable program code configured to receive designation of a subrange within the designated range using the controls on the slider; computer usable program code configured to update the slider control in response to the receiving steps; and computer usable program code configured to output a digital signal to a graphical display device for graphically depicting the controls of the slider at ends of the range and subrange.

In another general embodiment, a system includes a processor operative to execute computer usable program code; at least one of a network interface and a peripheral device interface for receiving user input; and a computer usable medium having computer usable program code embodied therewith, the computer usable program code comprising: computer usable program code configured to generate a slider having end values; computer usable program code configured to receive designation of a range between the end values, or including no more than one of the end values, using controls on the slider; computer usable program code configured to receive designation of a subrange within the designated range using the controls on the slider; computer usable program code configured to update the slider control in response to the receiving steps; and computer usable program code configured to output a digital signal to a graphical display device for graphically depicting the controls of the slider at ends of the range and subrange.

As will be appreciated by one skilled in the art, the present invention may be embodied as a system, method or computer program product. Accordingly, the present invention may take the form of an entirely hardware embodiment, a software embodiment (including firmware, resident software, micro-code, etc.) operating an apparatus or an embodiment combining software and hardware aspects that may all generally be referred to herein as a “circuit,” “module” or “system.” Furthermore, the present invention may take the form of a computer program product stored in any tangible medium of expression having computer-usable program code stored in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

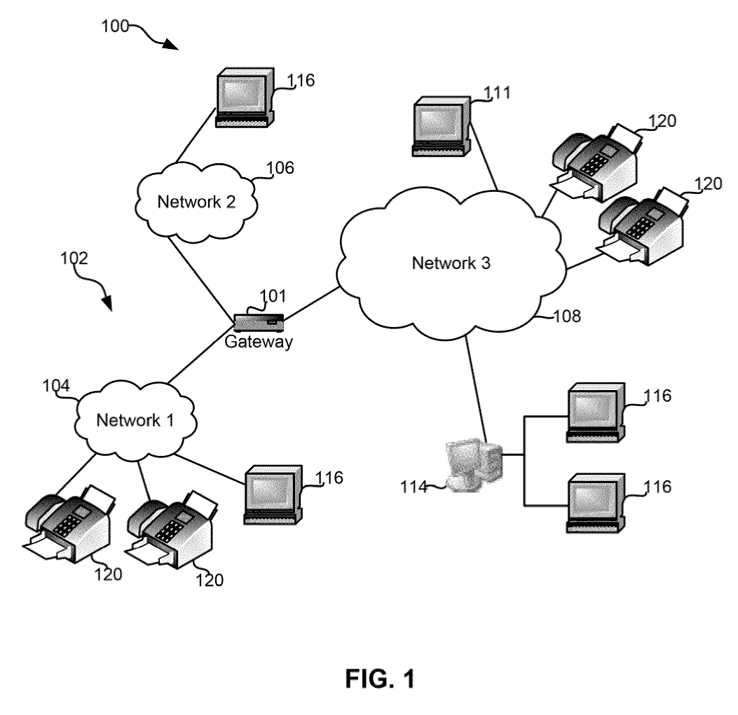

FIG. 1 illustrates a network architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, PSTN, internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, lap-top computer, hand-held computer, printer or any other type of logic. It should be noted that a user device 11I may also be directly coupled to any of the networks, in one embodiment.

A peripheral 120 or series of peripherals 120, e.g., facsimile machines, printers, networked storage units, etc. may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

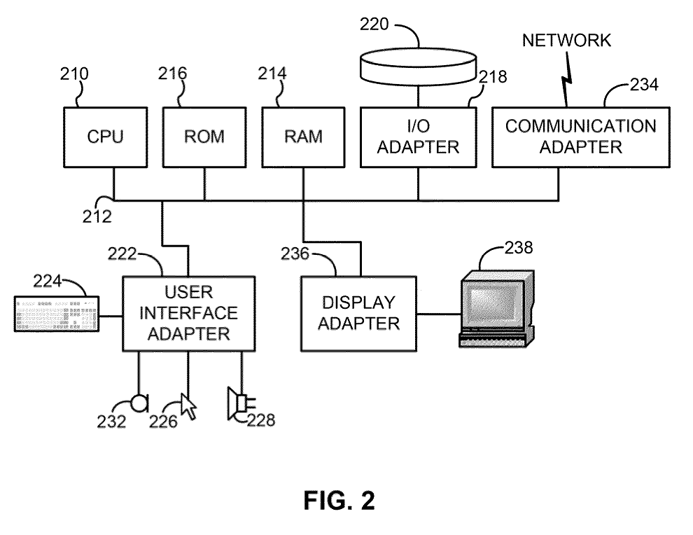

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, or UNIX operating system. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

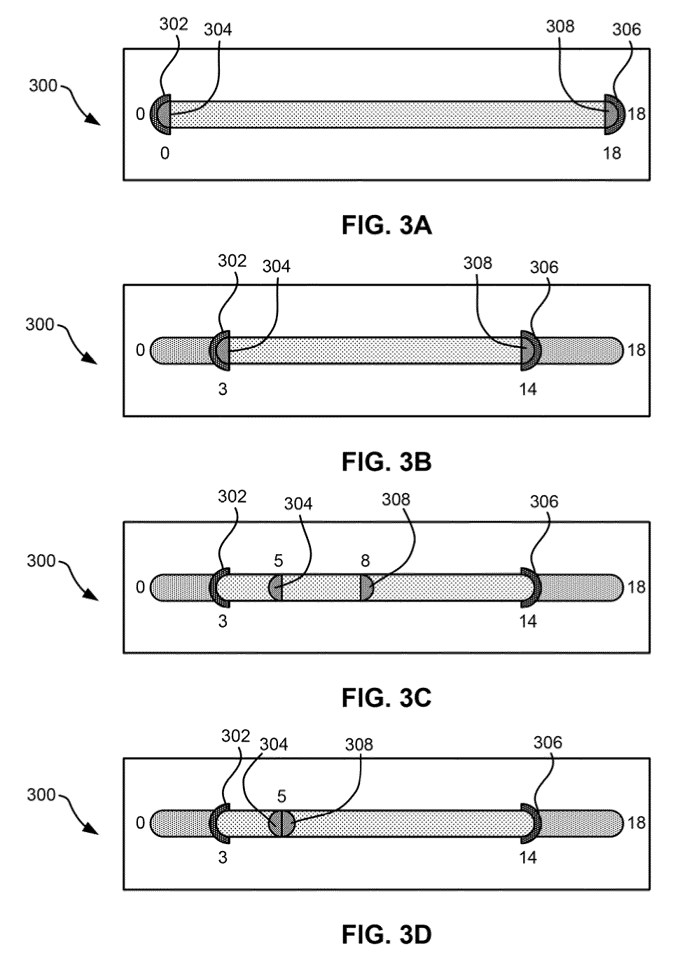

FIGS. 3A-3D illustrate a slider control 300 according to one embodiment. The slider control 300 may be horizontal (as shown), may be vertical, etc. The slider control can be used for many things. In one approach, a horizontal slider control may be used to move sideways across information on a page, while a vertical slider control may be used to scroll up and down on a page. In other approaches, the slider control may be used to set a range of numerical values, where the numerical values may be preassociated with some item, object, series, collection, sequence, parameter, etc.

In FIG. 3A, the slider control 300 is shown, possibly in an initial state which may appear when a page, configuration screen, selection screen, etc. is loaded or navigated to for the first time, and/or when a user has not yet operated the slider control 300. The slider control 300 may be generated by computer usable code. Each end of the slider control 300 includes one or more adjustable range controls. In FIG. 3A, each end of the slider includes a range control, lower range control 302 on the left end and upper range control 306 on the right end of the slider control 300. In addition, each end of the slider control 300 includes a subrange control, lower subrange control 304 on the left end and upper subrange control 308 on the right end.

In some embodiments, the slider control 300 may include positional indications, such as a number range, as shown in FIGS. 3A-3D. Other positional indications may be used, such as letters, colors, etc., to indicate a relative position of some or all of the range and subrange controls and the overall range. In FIG. 3A, numbers are shown indicating a relative position of the range controls 302, 306, at the extent of the overall range.

In FIG. 3B, the slider control 300 is shown where the range controls 302, 306 have been positioned to set a range of valid values. As the range controls 302, 306 are moved, the positional indicator number changes as well to indicate a relative position on the overall panel. In FIG. 3B, the subrange has been limited to 3-14 of a total of 18, by positioning the lower range control 302 at a position of about 3, and positioning the upper range control 306 to a position of about 14.

In some embodiments, the viewable area of the settings may be limited by the position of the lower range control 302 and the upper range control 306.

In FIG. 3C, a subrange is indicated on the slider control 300 by positioning a lower subrange control 304 at a position of about 5 and the upper subrange control 308 at a position of about 8. This position of the subrange controls may indicate the preferred target portion of the range. The subrange control 304,308 may include a gravity and/or snap-to characteristic with the range control 302, 306, such that the subrange controls “break away” from the range controls with a tug on a user interface device, such as a mouse, trackball, stylus pen, etc.

In some embodiments, the inner range/target setting may be limited by the position of the lower subrange control 304 and the upper subrange control 308.

According to some embodiments, the range and/or subrange may be activated redundantly through a menu item interface, such as by selecting the positional indicator value from a context menu, or by selecting numeric values in a numeric entry field and/or spin button, etc.

In FIG. 3D, the subrange controls 304, 308 have been positioned to a single point, indicated as a position of about 5 on the scale. In some embodiments, the subrange controls 304, 308 may include a gravity and/or snap-to characteristic such that when they are positioned together to form a point, they can be moved together with a single “click and drag” type motion, rather than requiring to be moved independently.

In one example of use, a range or subrange designated by the slider control may limit the setting to a portion of the overall range associated with the range or subrange.

In another example of use, a range or subrange designated by the slider control may limit a collection of viewable pages to some range and/or subrange. For example, assuming a collection has 18 pages, the slider position of FIG. 3C designates pages 3-14 in a range, and 5-8 in a subrange. Further processing may occur, such as searching for items within a page in the range or subrange, display is limited to only pages in the range or subrange, etc.

In another example of use, a range or subrange designated by the slider control may limit a set of selectable parameters to some range or subrange. For example, assuming data storage arrays can have up to 18 drives, the slider position of FIG. 3B may designate a user's desire to dynamically allocate the number of drives in a system within the range of 3 to 14, and then the slider control position in FIG. 3C may designate a user's desire to set a higher-priority target inner range for the system to ideally have between 5 and 8 drives.

In another example of use, a range or subrange designated by the slider control may set a different type of configuration parameter to some range or subrange, such as memory allocation ranges, CPU allocation ranges, Input/Output allocation ranges, etc.

As evident from the foregoing and other teachings herein, various embodiments of the slider control have broad applicability to any application where it would be useful to designate a range and subrange in a larger range.

Moreover, the slider control shown is but one example of the many types of configurations that may be employed using the teachings presented herein, and the inventive concepts herein are not to be limited by disclosure of any of the illustrative examples.

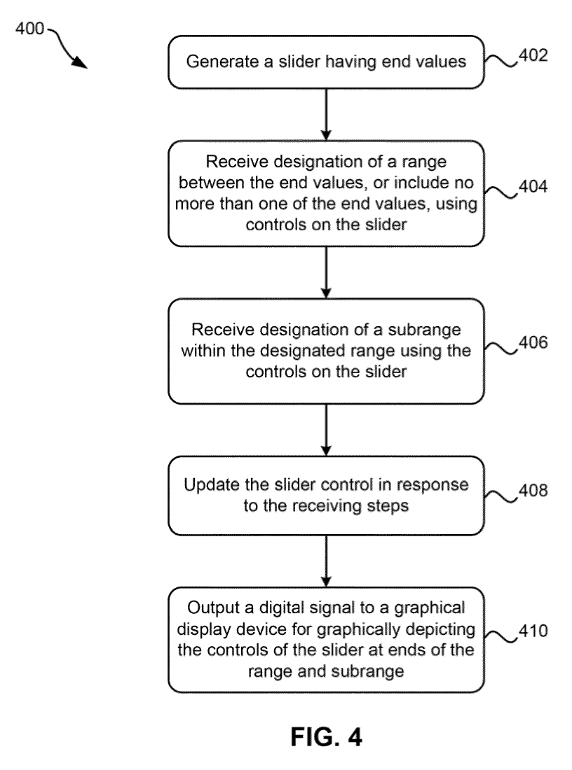

Now referring to FIG. 4, a method 400 is shown according to one embodiment. The method 400 may be used in any desired environment, and preferably it may be used in a computer system for controlling the position of a view on a display.

In operation 402, a slider is generated having end values representative of real world items or characteristics thereof, e.g., transformed from information about the real world items. For example, the end values may be set at 0 and 100, indicating a percent of an overall view.

In operation 404, designation is received of a range between the end values, or including no more than one of the end values, using controls on the slider. For example, a user may position one of the controls on the slider into a position on the slider, thus indicating a position at which to set as a limit for the overall range.

In operation 406, designation of a subrange is received within the designated range using the controls on the slider. For example, a user may position one of the subrange controls on the slider into a position on the slider, thus indicating a position at which to set as a sublimit for the subrange setting.

In some embodiments, receiving designation of the subrange within the designated range using the controls on the slider may include detecting manipulation of a position of the controls on the slider.

In more embodiments, receiving designation of the subrange within the designated range using the controls on the slider includes detecting a request applied to one of the controls, and outputting a user interface element such as a menu, field, second slider, etc., for receiving values of the subrange.

In some embodiments, a second subrange designation may be received within the designated range using the controls on the slider. For example, a user may designate two subranges within the range, and each subrange may be exclusive of one another, or may overlap.

According to some approaches, the slider controls may include nested markers for marking the range, and the method 400 may further comprise allowing separation of at least one of the nested markers into submarkers for designation of the range and subrange, possibly as shown in FIGS. 3A-3D. In further approaches, the method 400 may further comprise applying a gravity effect and/or a snap-to effect to the submarkers.

In more embodiments, a third subrange designation may be set having values outside the designated range using the controls on the slider.

In some approaches, the subrange may be a single point. For example, the subrange controls may be targeted to a single point on a scale, thereby designating the single point as the target subrange. Once a single point is designated, the subrange controls may be moveable as a single point, thereby allowing easier movement of the target point.

In operation 408, the slider control is updated in response to the receiving steps. For example, if the user moves a range and/or subrange control on the slider, the slider may reflect the movement of the control. In another example, if the user chooses a range and/or subrange from a menu, such as a pull down menu, then the slider control may be updated with the position of the range and/or subrange after receiving the input from the user.

In operation 410, a digital signal is output to a graphical display device for graphically depicting the controls of the slider at ends of the range and subrange. For example, the slider may look similar to the slider control shown in FIGS. 3A-3D. Of course, the slider may appear in any shape and form on the graphical display device, and that shown in FIGS. 3A-3D is only a single embodiment, not meant to be limiting in any way.

In one embodiment, one or more of the methods described above may be executed as a computer program product. The computer program product may include a computer usable medium having computer usable program code embodied therewith, the computer usable program code comprising the following functions.

The computer usable program code may be configured to generate a slider having end values, and may be configured to receive designation of a range between the end values, or including no more than one of the end values, using controls on the slider.

The computer usable program code may also be configured to receive designation of a subrange within the designated range using the controls on the slider, and may be configured to update the slider control in response to the receiving steps.

In addition, the computer usable program code may be configured to output a digital signal to a graphical display device for graphically depicting the controls of the slider at ends of the range and subrange.

In some embodiments, the computer program product may further comprise computer usable program code configured to receive designation of a second subrange within the designated range using the controls on the slider.

In more embodiments, the computer program product may further comprise computer usable program code configured to receive designation of a third subrange having values outside the designated range using the controls on the slider.

In some approaches, the computer program product may be operable such that the slider controls include nested markers for marking the range, and may further comprise allowing separation of at least one of the nested markers into submarkers for designation of the range and subrange. In further approaches, the computer program product may further comprise computer usable program code configured to apply a gravity and/or a snap-to effect to the submarkers. This may allow for easier movement of and positioning of the markers and/or submarkers.

In some embodiments, the subrange may be a single point. This single point may be designated by positioning one or both submarkers on a single point on a scale.

According to some embodiments, receiving designation of the subrange within the designated range using the controls on the slider may include detecting manipulation of a position of the controls on the slider. For example, a user may position controls on the slider to indicate the designated range.

In some more embodiments, the computer usable program code configured to receive designation of the subrange within the designated range using the controls on the slider may include computer usable program code configured to detect a request applied to one of the controls, and output a user interface element such as a menu, field, second slider, etc., for receiving values of the subrange.

According to one embodiment, a system comprises a processor operative to execute computer usable program code and a network interface and/or a peripheral device interface for receiving user input. The system also includes a computer usable medium having computer usable program code embodied therewith, the computer usable program code comprising the following functionality.

The computer usable program code may be configured to generate a slider having end values, and may be configured to receive designation of a range between tile end values, or including no more than one of the end values, using controls on the slider.

The computer usable program code may also be configured to receive designation of a subrange within the designated range using the controls on the slider, and may be configured to update the slider control in response to the receiving steps.

In addition, the computer usable program code may be configured to output a digital signal to a graphical display device for graphically depicting the controls of the slider at ends of the range and subrange.

According to some embodiments, the system may further comprise computer usable program code configured to receive designation of a second subrange within the designated range using the controls on the slider.

In more embodiments, receiving designation of the subrange within the designated range using the controls on the slider may include detecting manipulation of a position of the controls on the slider.

In some approaches, the computer usable program code configured to receive designation of the subrange within the designated range using the controls on the slider may include computer usable program code configured to detect a request applied to one of the controls, and computer usable program code configured to output a user interface element such as a menu, field, second slider, etc., for receiving values of the subrange.

It will be clear that the various features of the foregoing methodologies may be combined in any way, creating a plurality of combinations from the descriptions presented above.

It will also be clear to one skilled in the art that the methodology of the present invention may suitably be embodied in a logic apparatus comprising logic to perform various steps of the methodology presented herein, and that such logic may comprise hardware components or firmware components.

It will be equally clear to one skilled in the art that the logic arrangement in various approaches may suitably be embodied in a logic apparatus comprising logic to perform various steps of the method, and that such logic may comprise components such as logic gates in, for example, a programmable logic array. Such a logic arrangement may further be embodied in enabling means or components for temporarily or permanently establishing logical structures in such an array using, for example, a virtual hardware descriptor language, which may be stored using fixed or transmittable carrier media.

It will be appreciated that the methodology described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

Embodiments of the present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

Communications components such as input/output or I/O devices (including but not limited to keyboards, displays, pointing devices, etc.) can be coupled to the system either directly or through intervening I/O controllers.

Communications components such as buses, interfaces, network adapters, etc. may also be coupled to the system to enable the data processing system, e.g., host, to become coupled to other data processing systems or remote printers or storage devices through intervening private or public networks. Modems, cable modem and Ethernet cards are just a few of the currently available types of network adapters.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method, comprising:
generating a slider having end values;
receiving designation of a range between the end values, or including no more than one of the end values, using controls on the slider;
receiving designation of a subrange within the designated range using the controls on the slider;
updating the slider control in response to the receiving steps; and
outputting a digital signal to a graphical display device for graphically depicting the controls of the slider at ends of the range and subrange.

2. The method of claim 1, further comprising receiving designation of a second subrange within the designated range using the controls on the slider.

3. The method of claim 1, further comprising receiving designation of a third subrange having values outside the designated range using the controls on the slider.

4. The method of claim 1, wherein the slider controls include nested markers for marking the range, and further comprising allowing separation of at least one of the nested markers into submarkers for designation of the range and subrange.

5. The method of claim 4, further comprising applying at least one of a gravity and a snap-to effect to the submarkers.

6. The method of claim 1, wherein the subrange is a single point.

7. The method of claim 1, wherein receiving designation of the subrange within the designated range using the controls on the slider includes detecting manipulation of a position of the controls on the slider.

8. The method of claim 1, wherein receiving designation of the subrange within the designated range using the controls on the slider includes detecting a request applied to one of the controls, and outputting a user interface element for receiving values of the subrange.

9. A computer program product for outputting a slider, the computer program product comprising:
a computer usable medium having computer usable program code embodied therewith, the computer usable program code comprising:
computer usable program code configured to generate a slider having end values;
computer usable program code configured to receive designation of a range between the end values, or including no more than one of the end values, using controls on the slider;
computer usable program code configured to receive designation of a subrange within the designated range using the controls on the slider;
computer usable program code configured to update the slider control in response to the receiving steps; and
computer usable program code configured to output a digital signal to a graphical display device for graphically depicting the controls of the slider at ends of the range and subrange.

10. The computer program product of claim 9, further comprising computer usable program code configured to receive designation of a second subrange within the designated range using the controls on the slider.

11. The computer program product of claim 9, further comprising computer usable program code configured to receive designation of a third subrange having values outside the designated range using the controls on the slider.

12. The computer program product of claim 9, wherein the computer program product is operable such that the slider controls include nested markers for marking the range, and further comprising allowing separation of at least one of the nested markers into submarkers for designation of the range and subrange.

13. The computer program product of claim 12, further comprising computer usable program code configured to apply at least one of a gravity and a snap-to effect to the submarkers.

14. The computer program product of claim 9, wherein the subrange is a single point.

15. The computer program product of claim 9, wherein receiving designation of the subrange within the designated range using the controls oil the slider includes detecting manipulation of a position of the controls on the slider.

16. The computer program product of claim 9, wherein the computer usable program code configured to receive designation of the subrange within the designated range using the controls on the slider includes computer usable program code configured to detect a request applied to one of the controls, and output a user interface element for receiving values of the subrange.

17. A system, comprising:
a processor operative to execute computer usable program code;
at least one of a network interface and a peripheral device interface for receiving user input; and
a computer usable medium having computer usable program code embodied therewith, the computer usable program code comprising:
computer usable program code configured to generate a slider having end values;
computer usable program code configured to receive designation of a range between the end values, or including no more than one of the end values, using controls on the slider;
computer usable program code configured to receive designation of a subrange within the designated range using the controls on the slider;
computer usable program code configured to update the slider control in response to the receiving steps; and
computer usable program code configured to output a digital signal to a graphical display device for graphically depicting the controls of the slider at ends of the range and subrange.

18. The system of claim 17, further comprising computer usable program code configured to receive designation of a second subrange within the designated range using the controls on the slider.

19. The system of claim 17, wherein receiving designation of the subrange within the designated range using the controls on the slider includes detecting manipulation of a position of the controls on the slider.

20. The system of claim 17, wherein the computer usable program code configured to receive designation of the subrange within the designated range using the controls on the slider includes computer usable program code configured to detect a request applied to one of the controls, and computer usable program code configured to output a user interface element for receiving values of the subrange.
